(19) United States
(12) Patent Application Publication
(10) Pub. No.: US 2013/0185272 A1
(43) Pub. Date: Jul. 18, 2013

(54) GRAPHICAL SEARCH ENGINE

(71) Applicant: George Moser, Redwood City, CA (US)

(72) Inventor: George Moser, Redwood City, CA (US)

(21) Appl. No.: 13/351,168

(22) Filed: Jan. 16, 2012

(51) Int. Cl. G06F 17/30

(52) U.S. Cl. 707/706; 707/E17.108

(57) ABSTRACT

An Internet search engine with associated user interface is provided to facilitate use, particularly on devices with limited display size. Each search result is displayed using a graphical image associated with the result, and optionally associated text. Each result may be displayed using a significant portion of the total display area available. The amount of display area used to display a search result may vary depending upon the availability of significant images or relative importance of a search result to the underlying query.

### FIELD OF THE INVENTION

The present invention is in the computer software field, with focus on an improved search engine for Internet searching.

### BACKGROUND

Search engines for Internet searching such as Google, Yahoo and others have made an enormous wealth of information available to computer users and have made and continue to make a huge contribution to science, education, culture, business and general dissemination of human knowledge. Search engines have put great knowledge and information resources at the fingertips of the population regardless of their level of computer skills. Users of search engines include all segments of the population, from highly sophisticated users with advanced computer expertise to millions of users with very limited familiarity with computers and software.

However, one area with substantial room for improvement is the way the information found by the search engine is communicated to the user. Current search engines rely primarily on text to do that, which can be very tiring to the user who has to go through a very large set of available information. The task is even more difficult if the information is to be displayed on a mobile device with limited display size, such as a phone, PDA or other mobile device. The available display space in a mobile device is so small that the user faces a challenge when trying to read the tiny text that contains the result of his/her search. In many applications, a different approach may be desirable to facilitate the search process and make it practical for users on a variety of devices.

FIG. 1 shows a typical search engine using Google as an example. The screen is basically divided in three vertical columns:
column 11 is used for settings and other items of infrequent use or lesser importance;
column 13 is used for advertising;
column 12 is used for the actual search results, which are listed primarily as a text list

In addition, typically there is also a horizontal advertising banner 14 near the top of the screen.

FIG. 2 shows a typical search using Google, which shows the results as a long text list in the middle of the screen (area 22).

FIG. 3 shows the same search using Yahoo. The way the results are displayed is very similar.

FIG. 4 shows the same search using bing, the Microsoft search engine. The way the results are displayed is very similar too.

### BRIEF DESCRIPTION OF THE DRAWINGS

FIG. 1 is a schematic block diagram of a prior art search engine user interface.

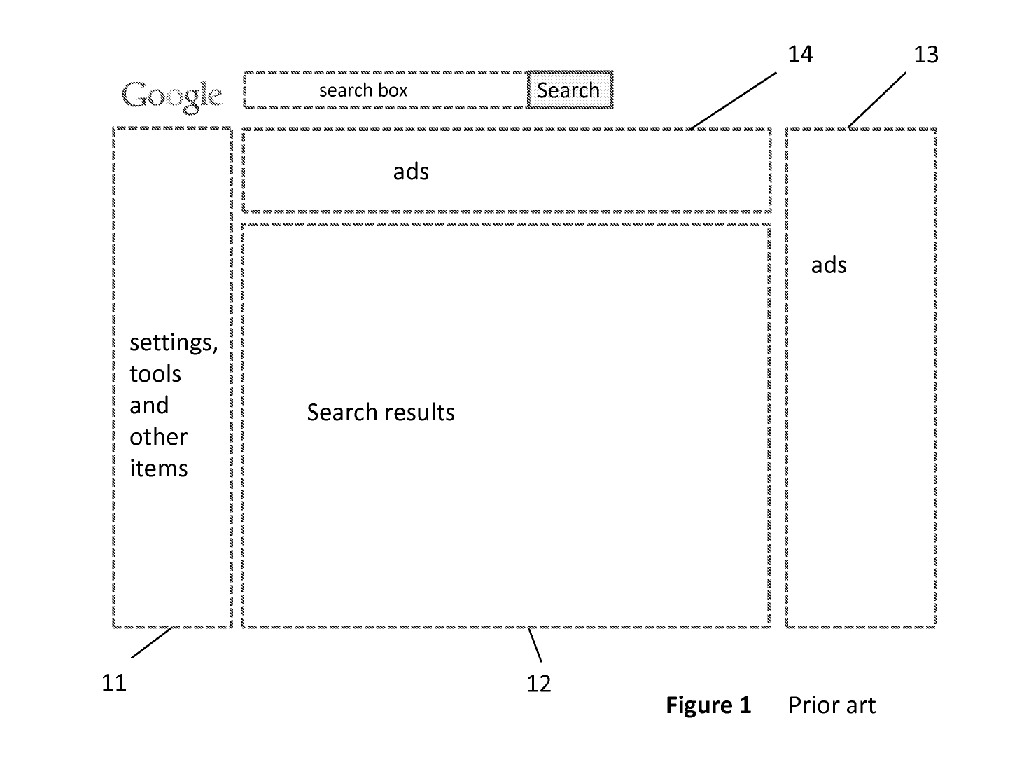

FIG. 2 is an illustration of a prior art search engine user interface.

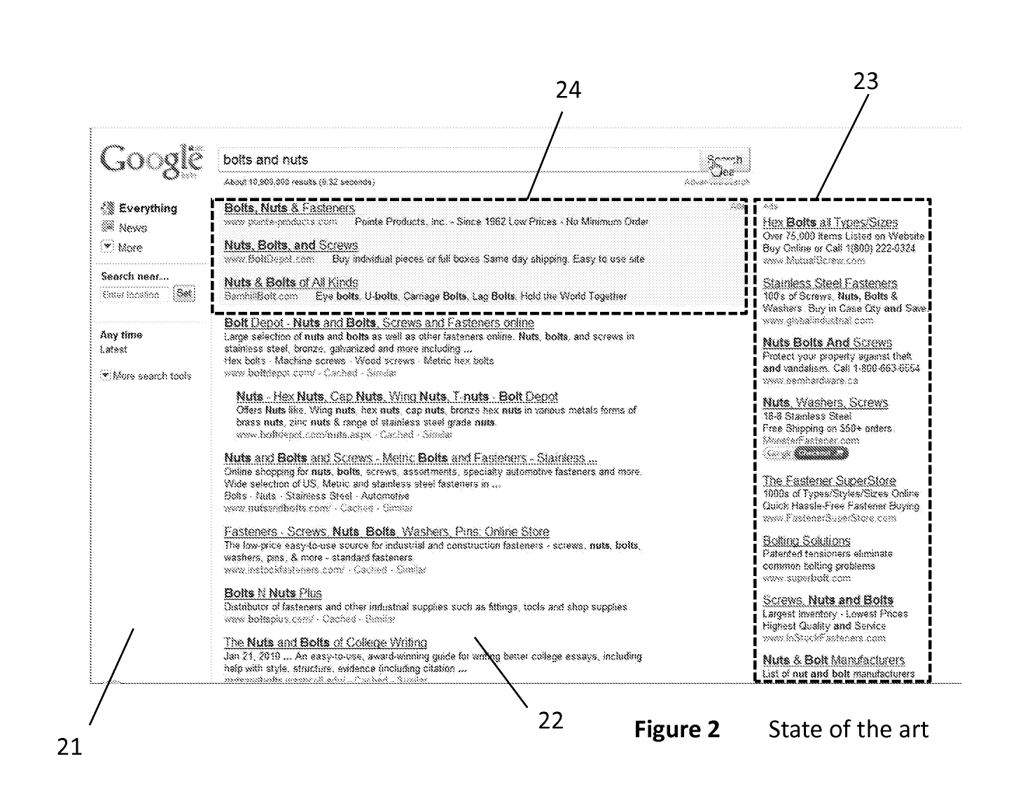

FIG. 3 is an illustration of a further prior art search engine user interface.

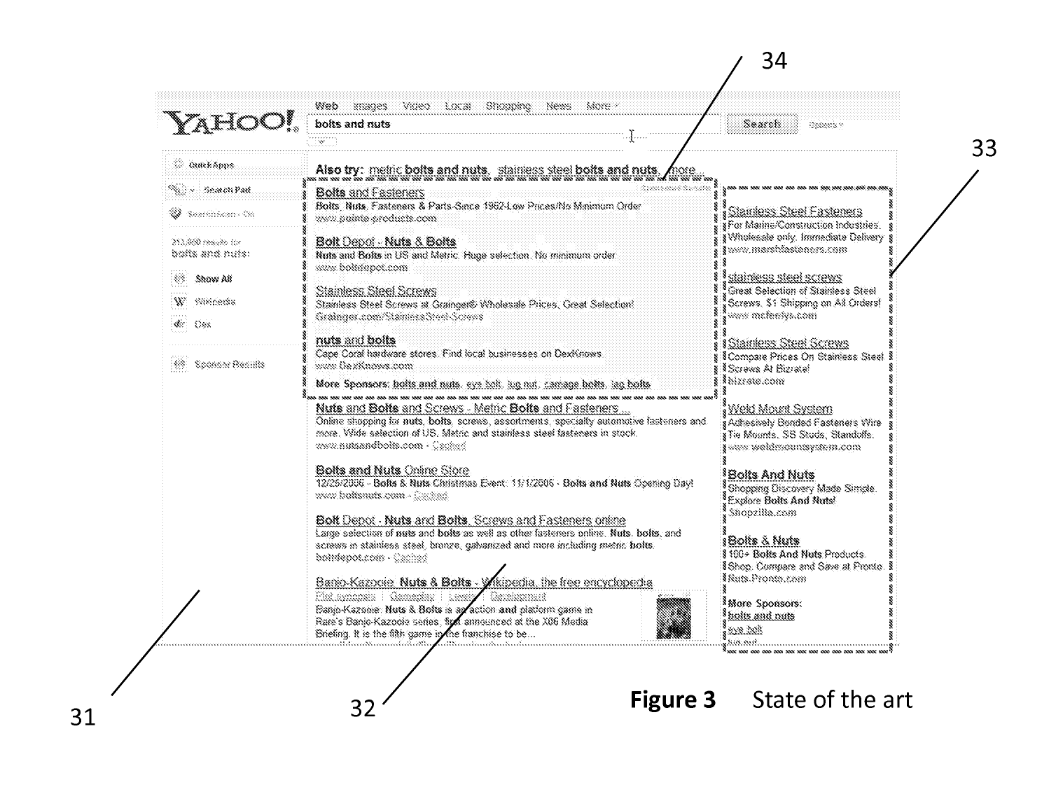

FIG. 4 is an illustration of yet another prior art search engine user interface.

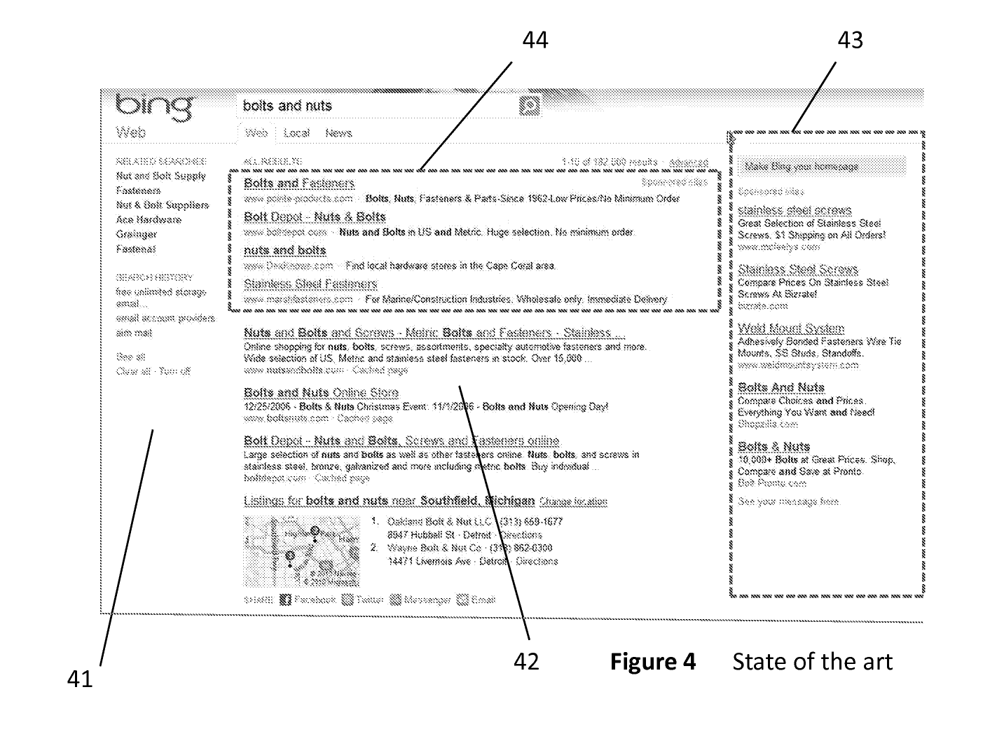

FIG. 5 is a schematic block diagram of a search engine user interface, in accordance with a first embodiment described herein.

FIG. 6 is a schematic block diagram of a further embodiment of a search engine user interface.

FIG. 7 is a schematic block diagram of yet another embodiment of a search engine user interface.

FIG. 8 is a schematic block diagram of yet another embodiment of a search engine user interface.

FIG. 9 is a schematic block diagram of yet another embodiment of a search engine user interface.

FIG. 10 is a front elevation of a mobile device.

FIG. 11 is a schematic block diagram of a mobile device search user interface.

FIG. 12 is a schematic block diagram of a further embodiment of a mobile device search user interface.

FIG. 13 is a schematic block diagram of yet another embodiment of a mobile device search user interface.

FIG. 14 is a schematic block diagram of yet another embodiment of a mobile device search user interface.

FIG. 15 is a front elevation of a further mobile device embodiment having an elongated screen.

FIG. 16 is a schematic block diagram of a search user interface for a mobile device having an elongated screen.

FIG. 17 is a schematic block diagram of a further embodiment of a mobile device search user interface.

FIG. 18 is a schematic block diagram of a prior art system for conducting an Internet search.

FIG. 19 is a schematic block diagram of a system for conducting a search in accordance with embodiments described herein.

FIG. 20 is a schematic block diagram of a prior art system for conducting a search using a mobile device.

FIG. 21 is a schematic block diagram of a system for conducting a search using a mobile device in accordance with embodiments described herein.

### DETAILED DESCRIPTION

Embodiments described herein provide alternative approaches to improve the way search results are communicated on desktop computers, laptop computers and especially on mobile devices such as phones.

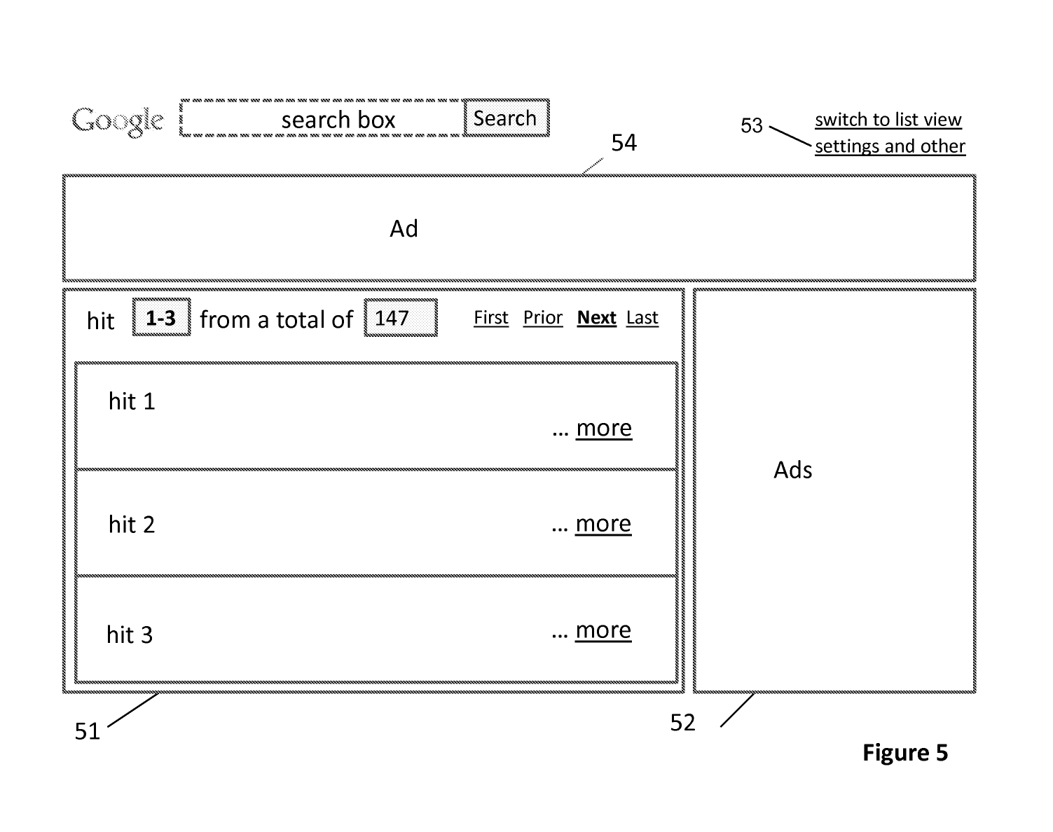

FIG. 5 illustrates a system and method for displaying search results, in accordance with one embodiment. In the embodiment of FIG. 5, the number of vertical columns has been reduced from 3 to 2. The customary left column (settings and other items) is replaced with a box or link to said functionality (see “settings and other” link 53 near the top right corner of the screen). Eliminating the current left column frees up valuable space on the screen that can be used for a more efficient layout.

Furthermore, in the embodiment of FIG. 5, the number of hits displayed at one time has been limited. The objective is to have a small number of total entries in the screen (preferably 4 or less) to make it possible to increase the size of the text used to make the text readable, even on a mobile device. In the embodiment of FIG. 5, a maximum of 3 in the search results is displayed at one time in panel 51 and one in the top banner 54. Alternatively there could be two entries in each of the two panels, with the same total of 4 entries, thereby avoiding reduction of text size to the point of making the search results more difficult to read. This approach also makes increased use of images for every entry possible, so that the user can largely rely on easy to see and easy to recognize images rather than having to read a massive amount of text. This approach does not need to sacrifice ad revenue, because the ad areas 54 and 52 can be preserved. Additionally the banner and the right hand side advertising panel can be refreshed with new ads (or even the same depending on the ad pricing scheme adopted) as the user navigates through subsequent screens.

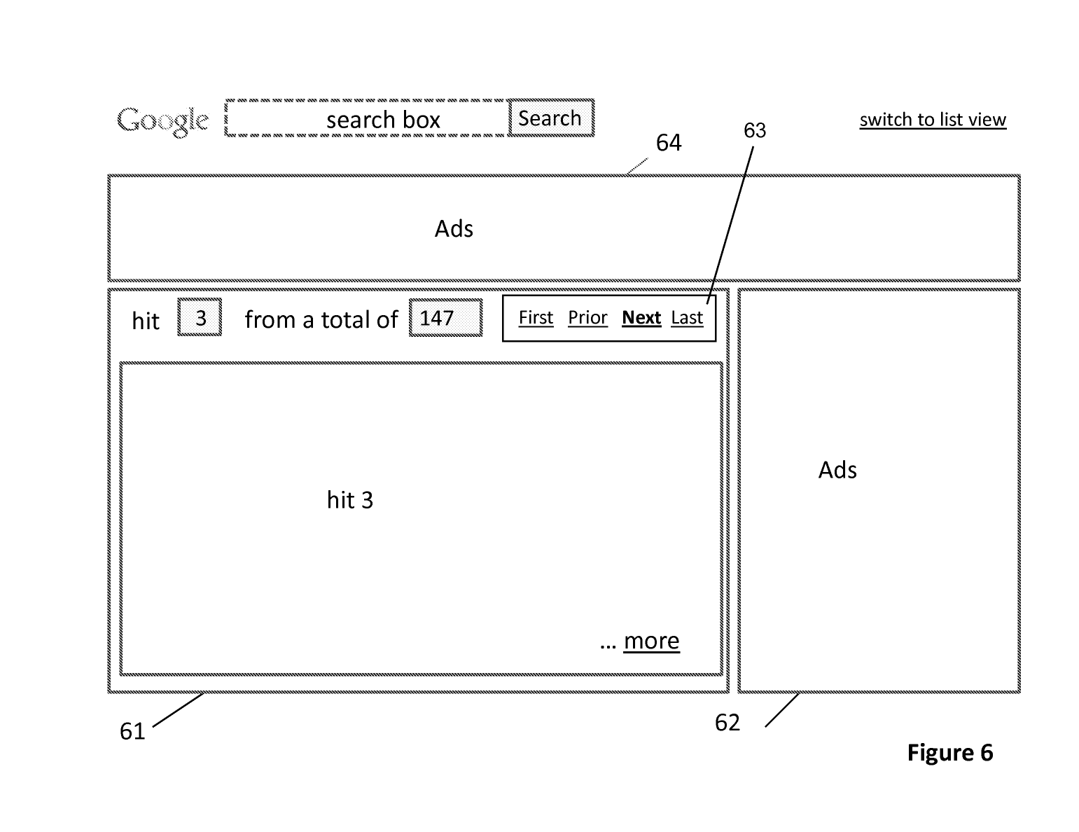

FIG. 6 illustrates a further embodiment, in which the number of search result hits per page is now limited to just one. Search result navigation controls 63 enable a user to cycle through search results, whereby the user can click on First, Prior, Next or Last to navigate to other search result hits. Large text can now be used for display of search hits within results pane 61, which for many users is a great benefit, especially (but not only) when using a mobile device.

A variation of the approach shown in FIG. 6 is to choose a dynamically variable maximum number of hits displayed per view. For instance if no images are available for some of the hits, or if the amount of information available for some of the hits is very small, or if a hit is judged by the search engine to be less important or less relevant, a smaller amount of space may be allocated to that hit, and in that case the search engine may choose to display a larger number of hits in one view, such as possibly 2 or 3 (or potentially even higher in some cases) instead of just one hit per view.

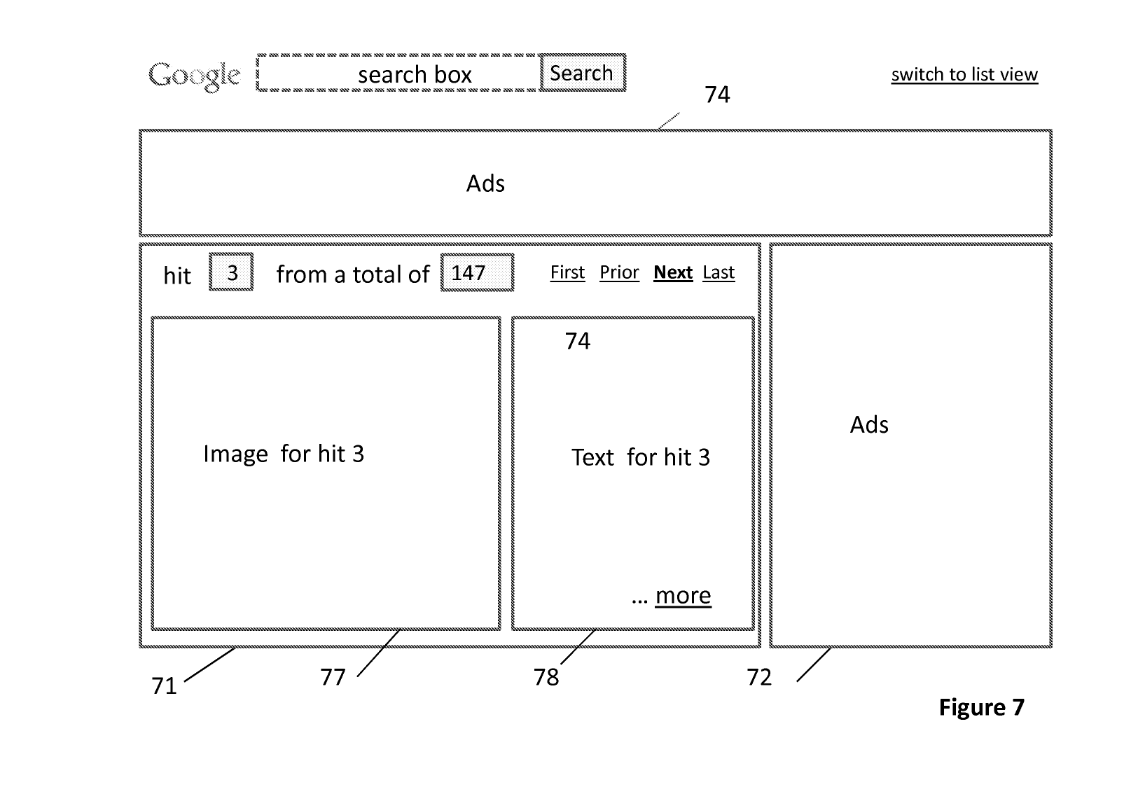

In accordance with another embodiment, FIG. 7 shows that the hit display area 71 includes an image area 77 and a text area 78. Image area 77 displays a graphical image associated with the current search result hit, while text area 78 displays text content associated with the current search result hit. This approach is very friendly on the eyes of the user, (especially but not only) when the user is using a mobile device. In accordance with one method of use, the user can initially focus on the images and read the text only after screening the hit based on the image. The images in many cases can be company or product logos (when applicable), which are often instantly recognized even without reading the accompanying text. This approach in many cases allows for a more efficient processing of information, depending on the type of information displayed.

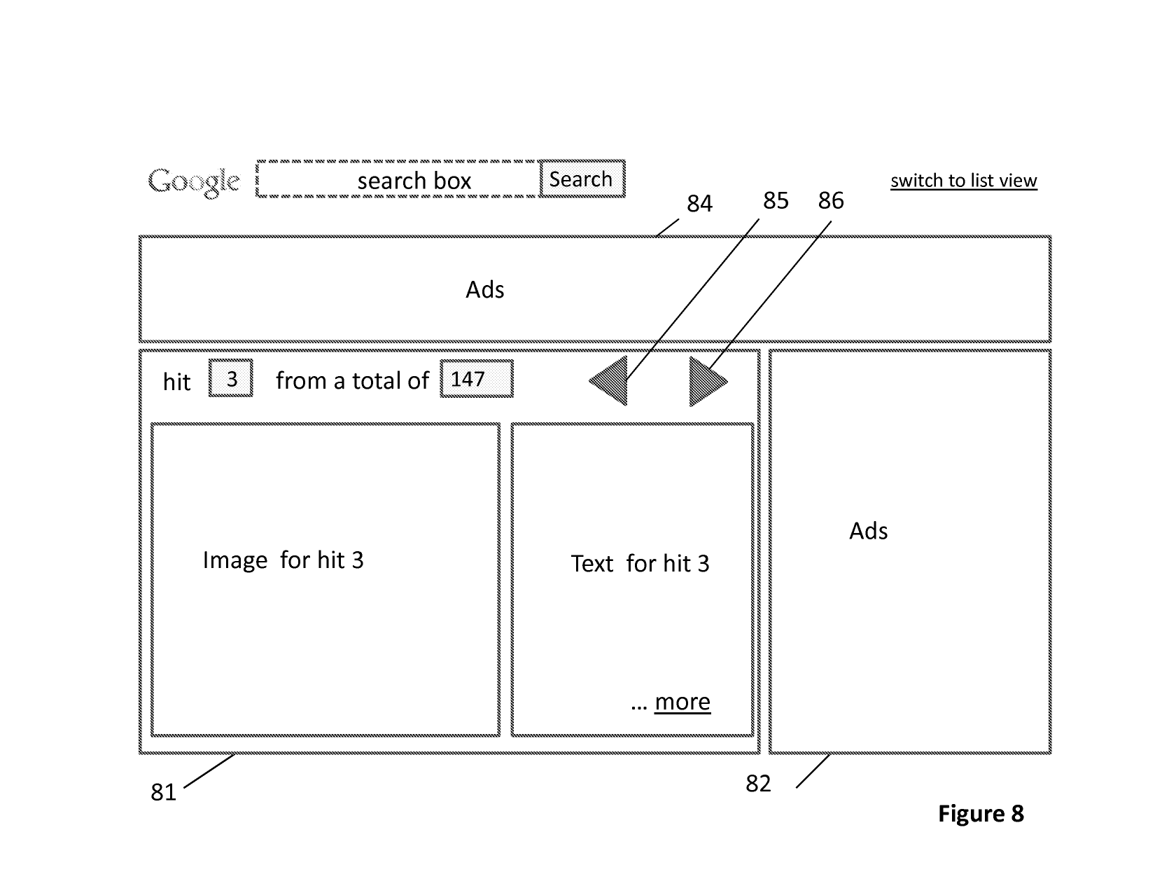

FIG. 8 shows that the user can now move forward or backward in the hits list by clicking on the navigation arrows 85 and 86 (instead of reading the text “Prior” and “Next”, selecting one of them and then clicking on it). The less the user is required to read, the better (especially on a mobile device).

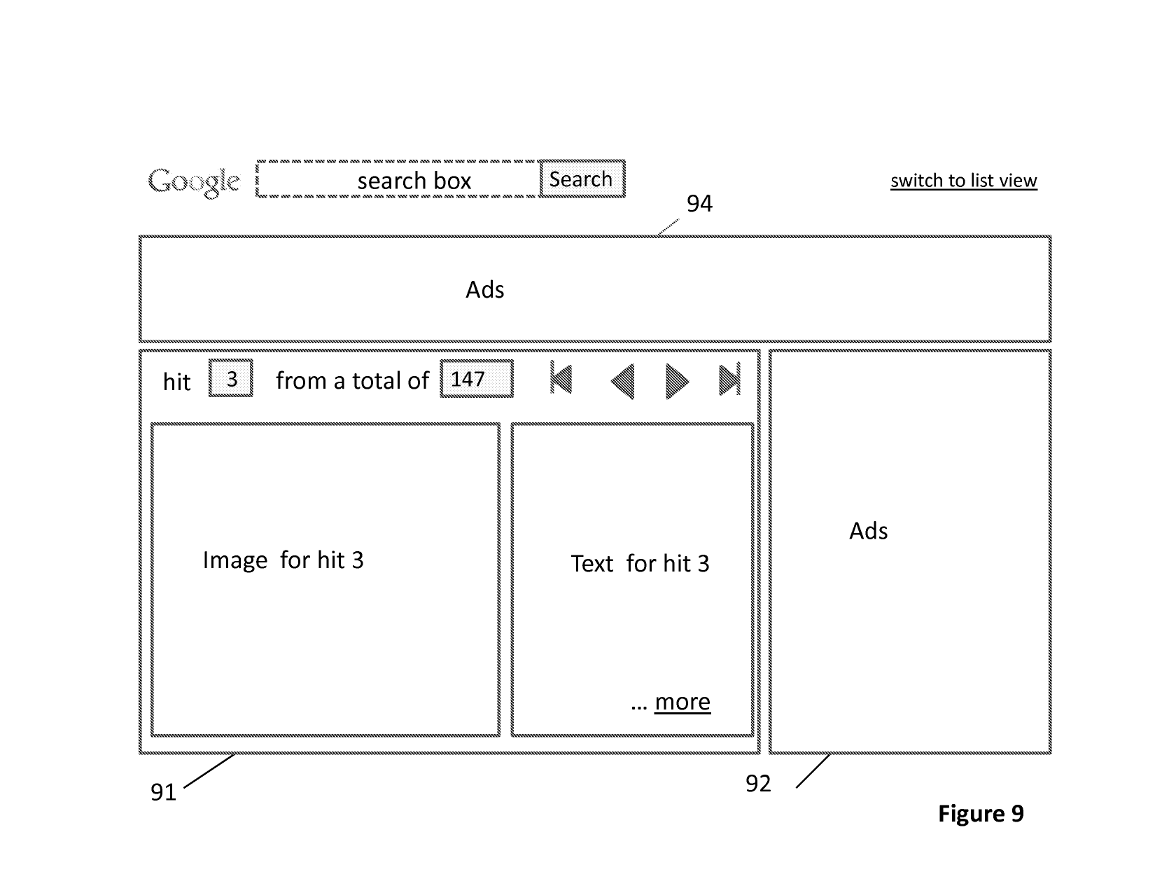

FIG. 9 is a slight variation of FIG. 8. Two more navigation buttons have been added to allow the user to quickly jump to the top of the results list or to the bottom of it (fast forward and fast backward).

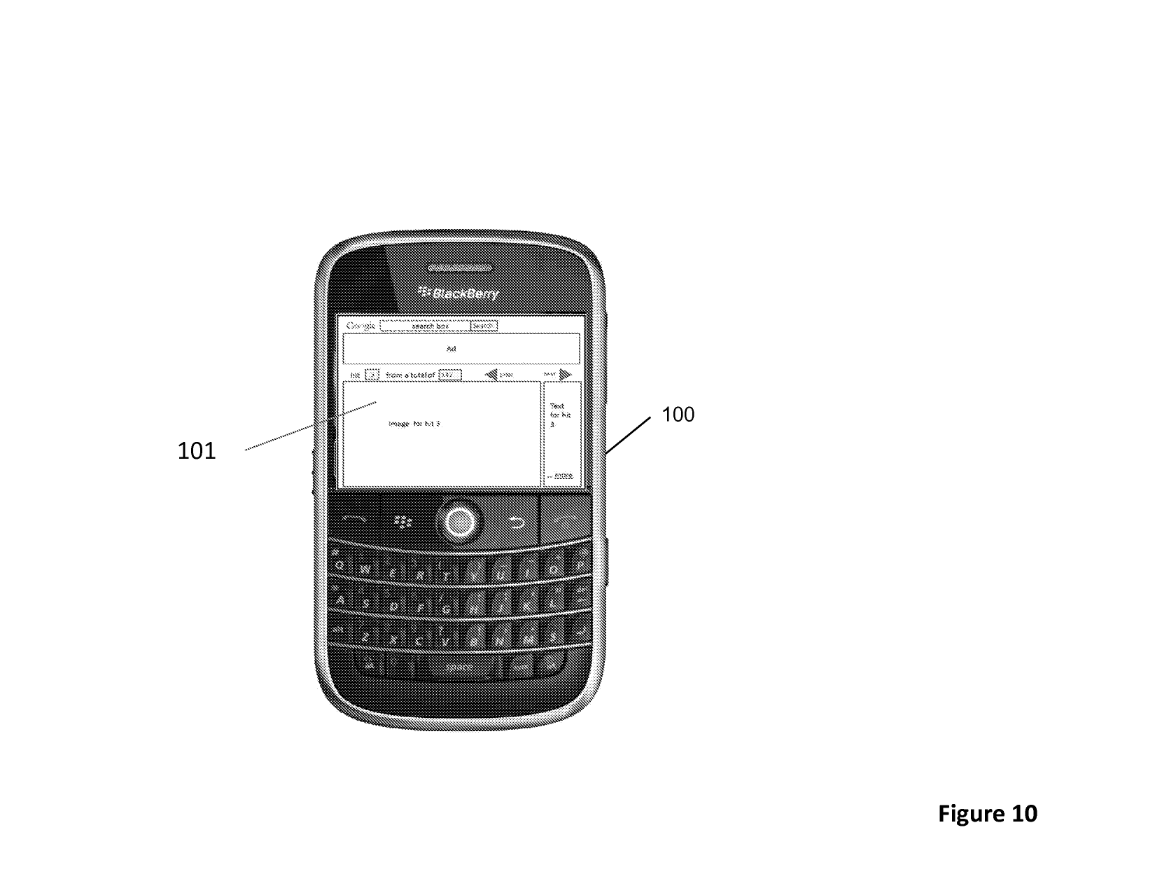

FIG. 10 shows that despite the small size of the display 101 of a typical mobile device 100 (such as a Blackberry device), the present invention enables the user to conduct an Internet search and actually see the results of the search in a convenient and readable way, which in many cases today is virtually impossible.

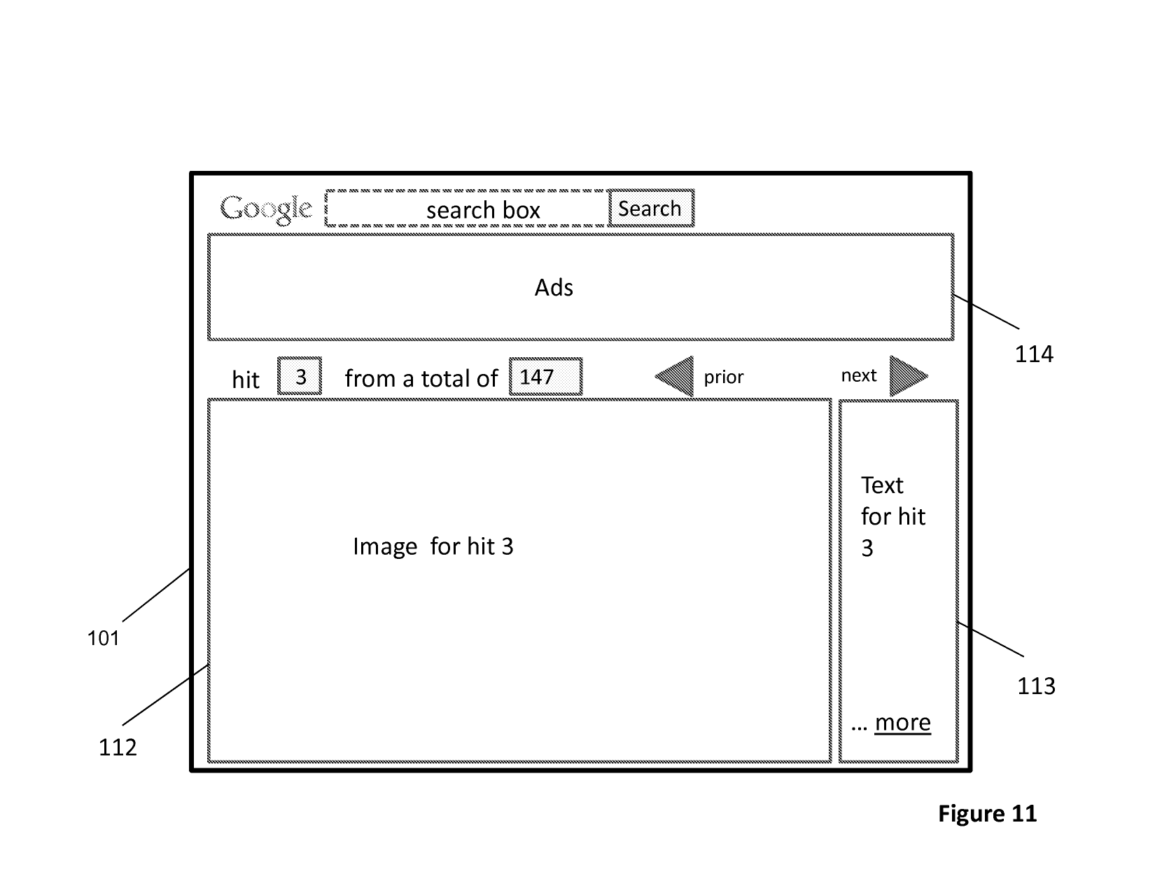

FIG. 11 shows an expanded view of the screen 101 of mobile device 100 (FIG. 10). Most of the area of the screen 101 has been assigned to one hit, in this case hit 3 of the list. The area assigned to hit 3 includes an image area 112 and a text area 113. The area 114 has been assigned to advertising.

Using the current approach in search engines, it would be very hard to squeeze a list of search results and also an advertising area into the screen of a mobile device, and still keep the text size large enough to make everything readable. Typically the compromise has been to reduce the text size to a level that it readable only with great difficulty. Embodiments described herein can help resolve that issue for many users.

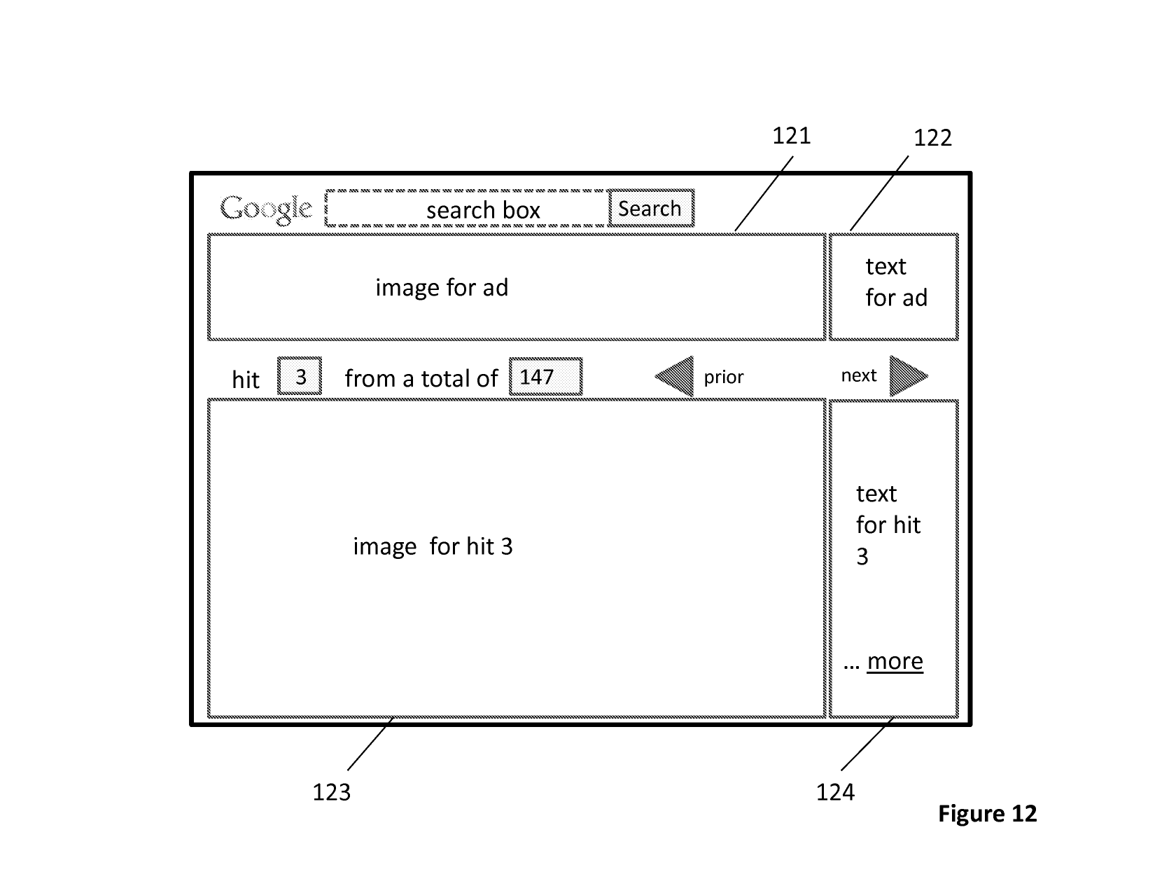

FIG. 12 shows a further embodiment of the search result display, in which the ad area at the top is divided into an image area 121 and a text area 122, following the same approach used to show the hits (panels 123 and 124). The relative size between image and text for all the four panels can be dynamically adjusted if necessary.

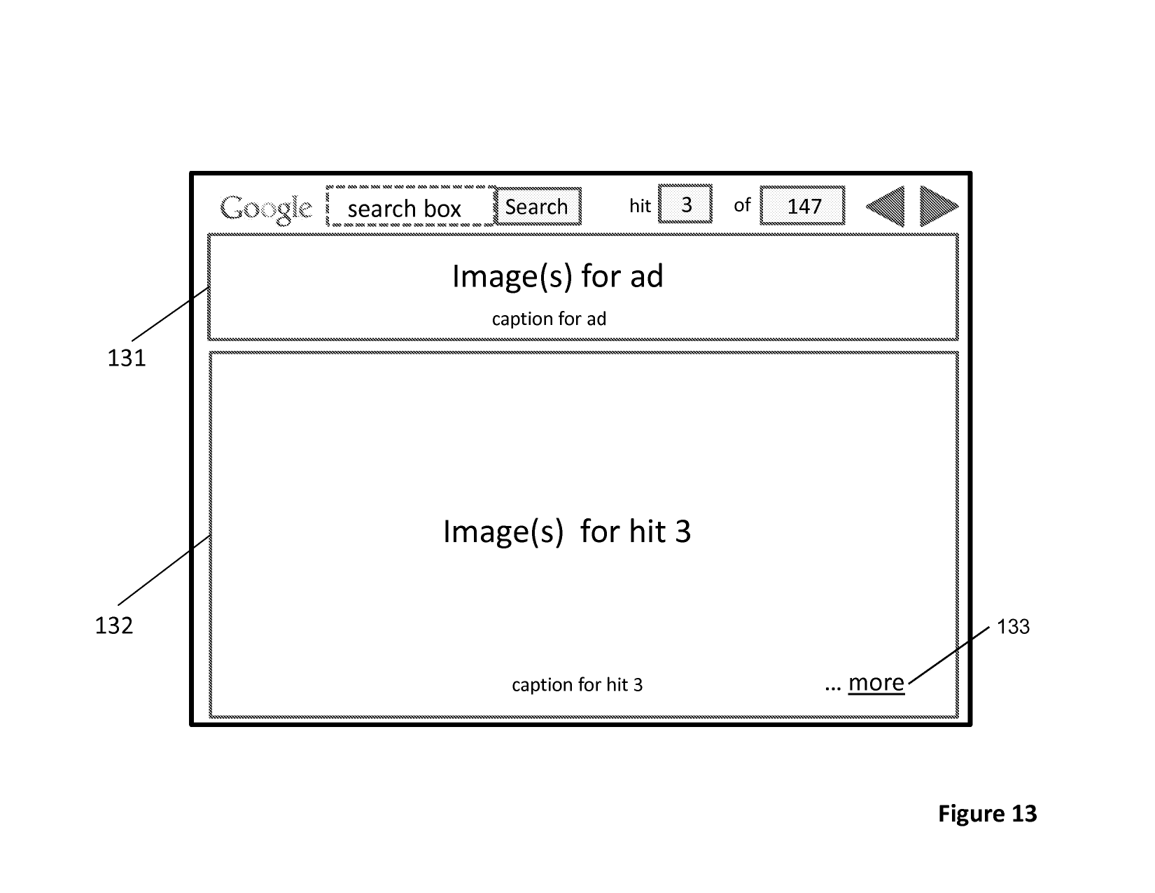

FIG. 13 shows a further embodiment of a method and user interface for display of search results, which is particularly useful for mobile devices. The whole display consists of basically two horizontal panels: panel 132 for the hits and panel 131 for advertising. Each one of the two panels consists primarily of images with an optional short caption. This method enables basically a graphical search of the results displayed on the screen. If an interesting hit is found by looking at the image (and caption), the user can click on the “ . . . more” text tag 133 to display detailed information about that hit.

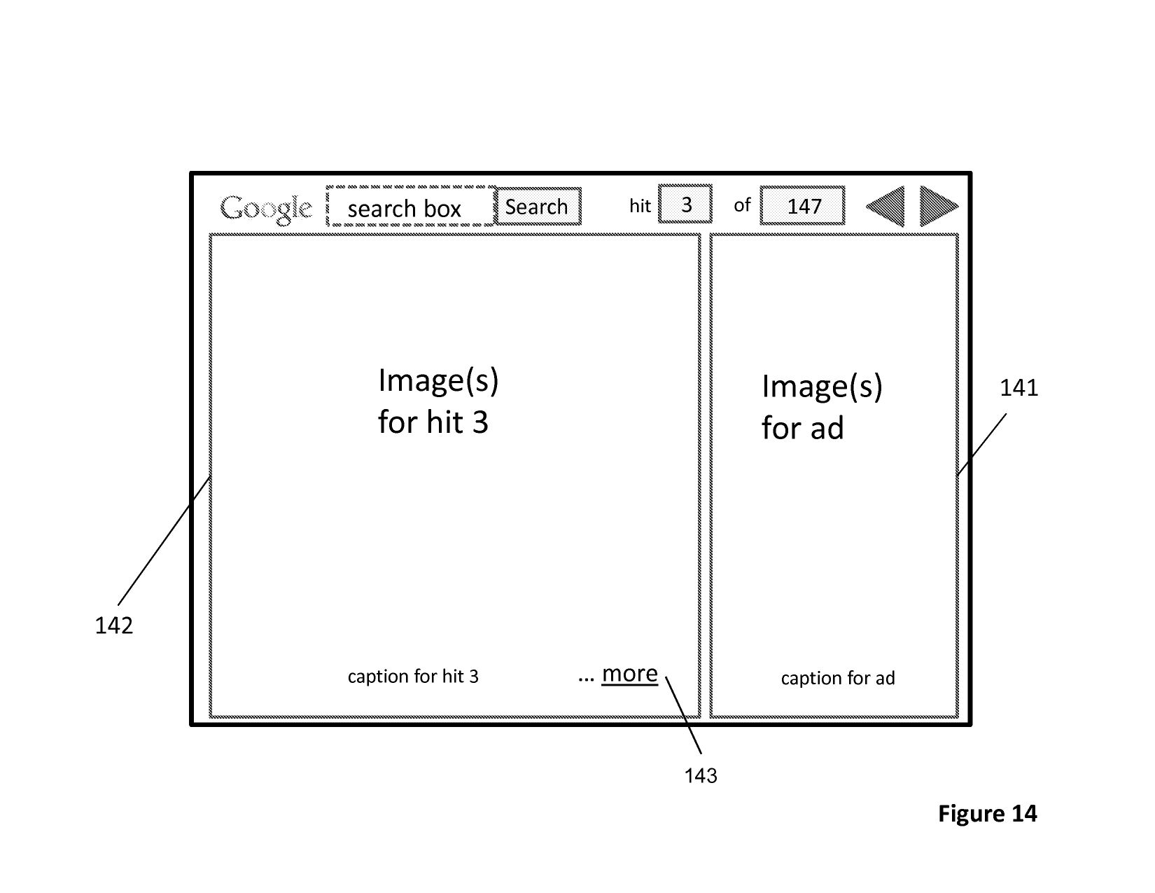

FIG. 14 shows a further embodiment of a method and user interface for display of search results, which is particularly useful for mobile devices. The whole display consists of basically two vertical panels: panel 142 for the hits and panel 141 for advertising. Each one of the two panels consists primarily of images with an optional short caption. This method enables basically a graphical search of the results displayed on the screen. If an interesting hit is found by looking at the image (and caption), the user can click on the “ . . . more” tag 143 to display detailed information about that hit.

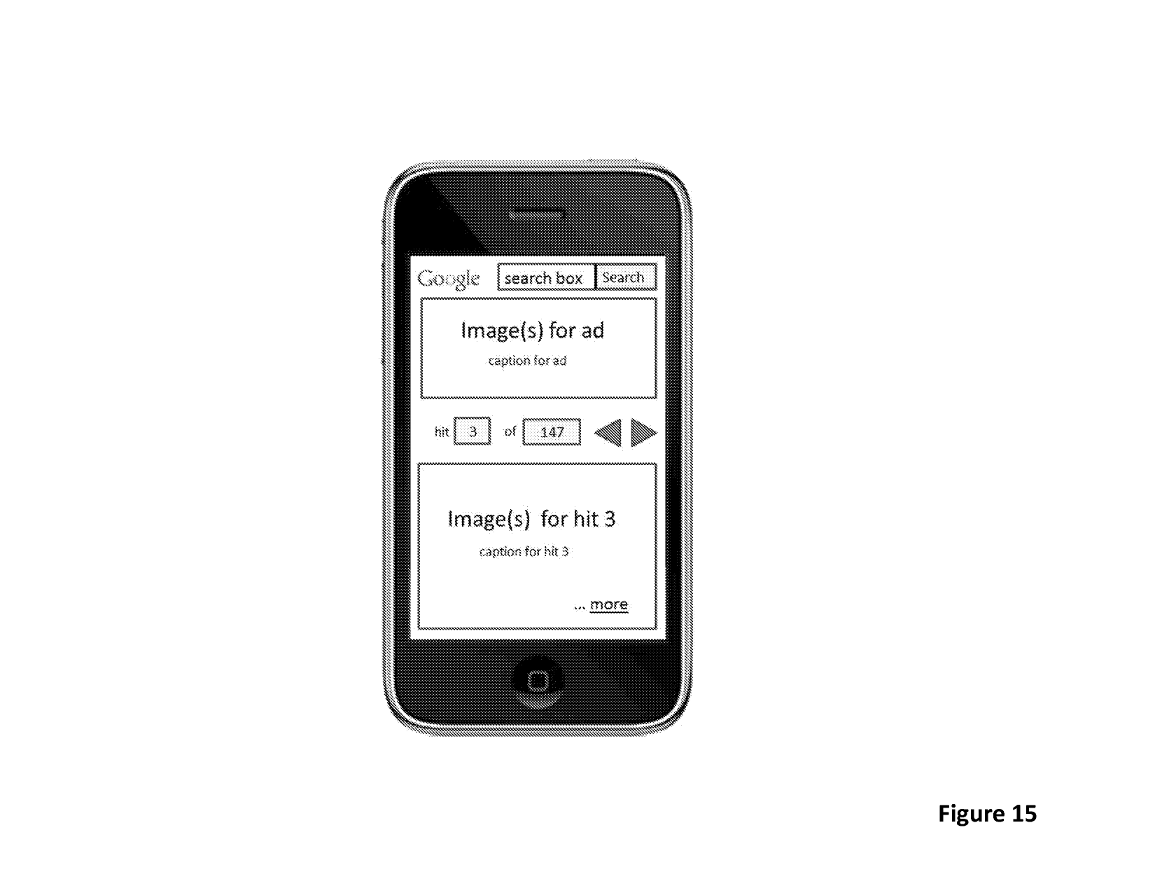

FIG. 15 illustrates an embodiment implemented on a device with different form factors from the one shown in FIG. 10. FIG. 15 shows a touchscreen phone such as the iPhone, which has a larger and more elongated screen available because of the lack of keyboard. This Figure shows that the image-oriented display methodology of this invention is very well-suited for this type of device too, providing excellent visibility and readability to the user.

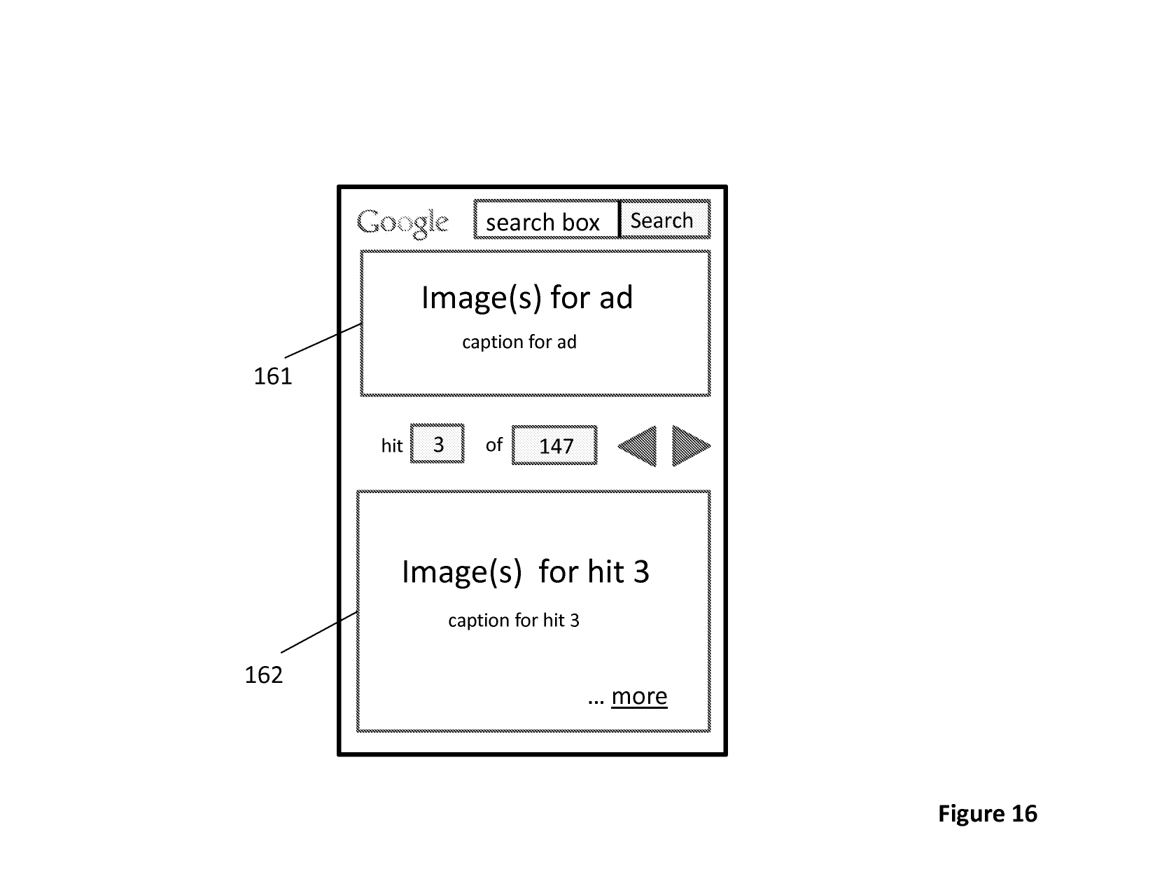

FIG. 16 shows an expanded view of the screen of FIG. 15, with an advertising panel 161 and a results panel 162.

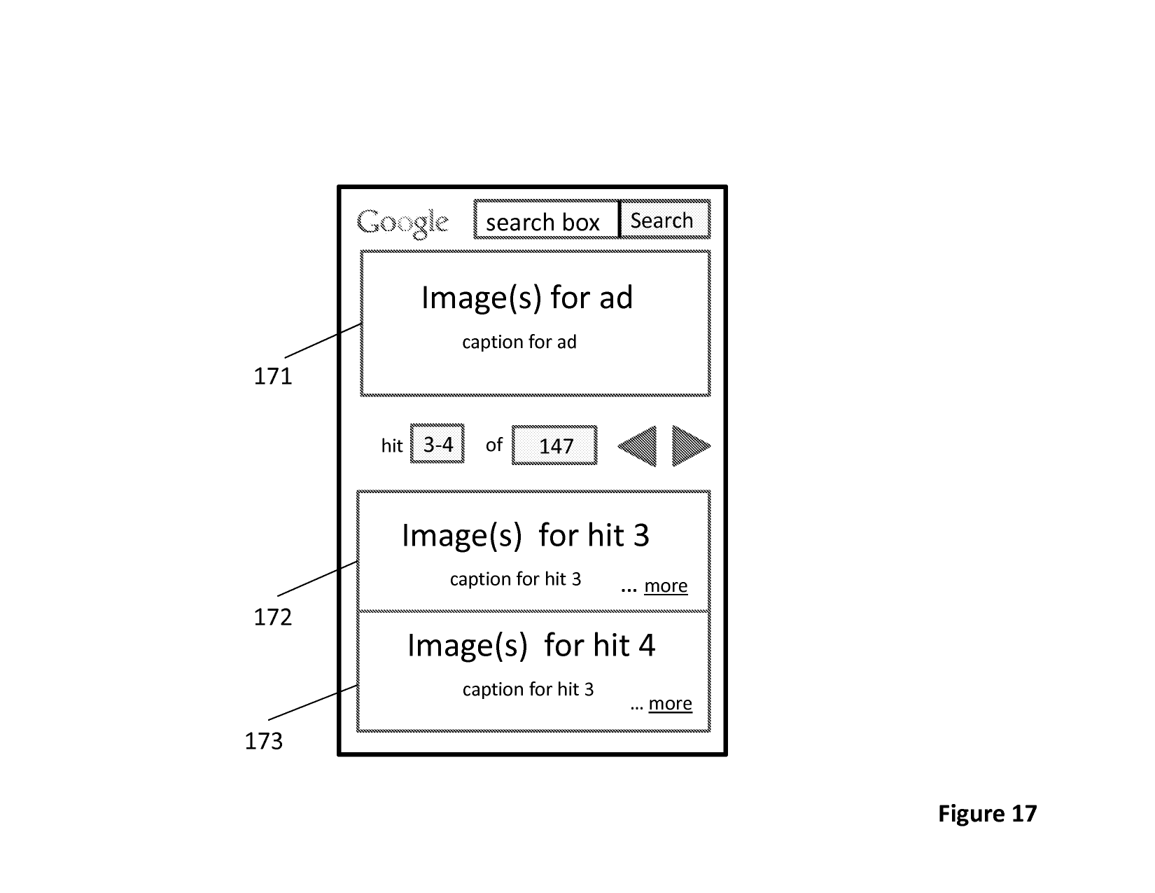

FIG. 17 shows that because of the larger screen available in the device of FIG. 15, it is also conceivable to display more than one hit (possibly 2 or 3) inside the results panel. This Figure shows two display panels 162 and 163 for hits.

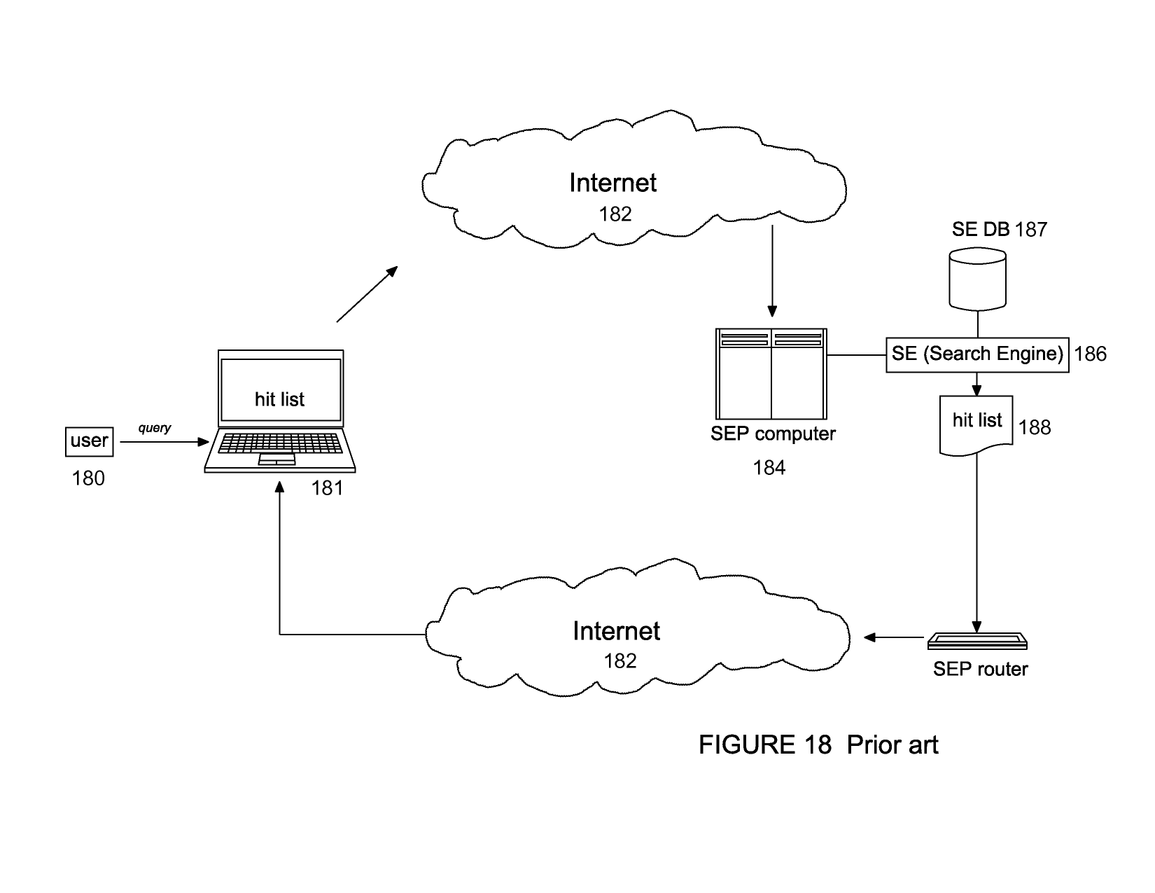

FIG. 18 (prior art) is used to describe how a typical Internet search is conducted using a PC 181. The user enters a query 180 (a search target), which is sent over the Internet 182 to the Search Engine Provider's (SEP) computer 184 to get processed by the Search Engine (SE) 186, which searches the Internet 182 as well as typically also its own database 187, generating a list of results 188 (the “hit list”). The hit list is sent back through the Internet 182 to the computer 181 that originated the search, which then displays the hits list on its screen, primarily as a text list.

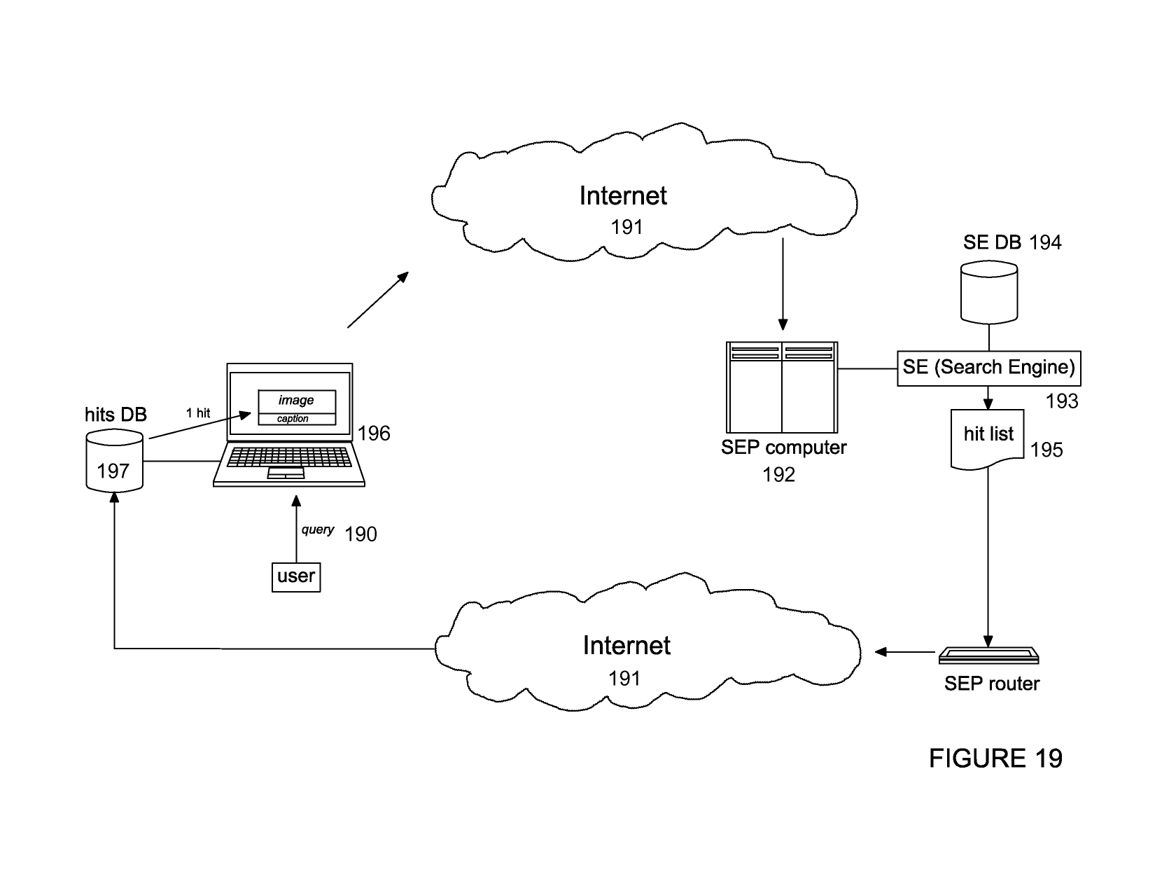

FIG. 19 describes the a search engine process using a computer to conduct the search. The user enters a query 190 (a search target), which is sent over the Internet 191 to the Search Engine Provider's (SEP) computer 192 to get processed by the Search Engine (SE) 193, which searches the Internet 191 as well as typically also its own database 194, generating a hit list 195. The hit list 195 is sent back through the Internet 191 to the computer 196 that originated the search. The computer 196 saves the hit list in a data base 197 or as a data buffer in its internal memory and/or on the hard disk, from which a subset (preferably one hit at a time) is extracted to be displayed on the screen, as the user navigates through the list. The screen display is graphics oriented, consisting primarily of images with captions. The hits database or buffer 197 may contain more than one hit list in order to allow the user to almost instantly view any hit related to his/her search (i.e. while the user is inspecting the hit list, other hit lists are downloaded from the search engine and loaded into the data base).

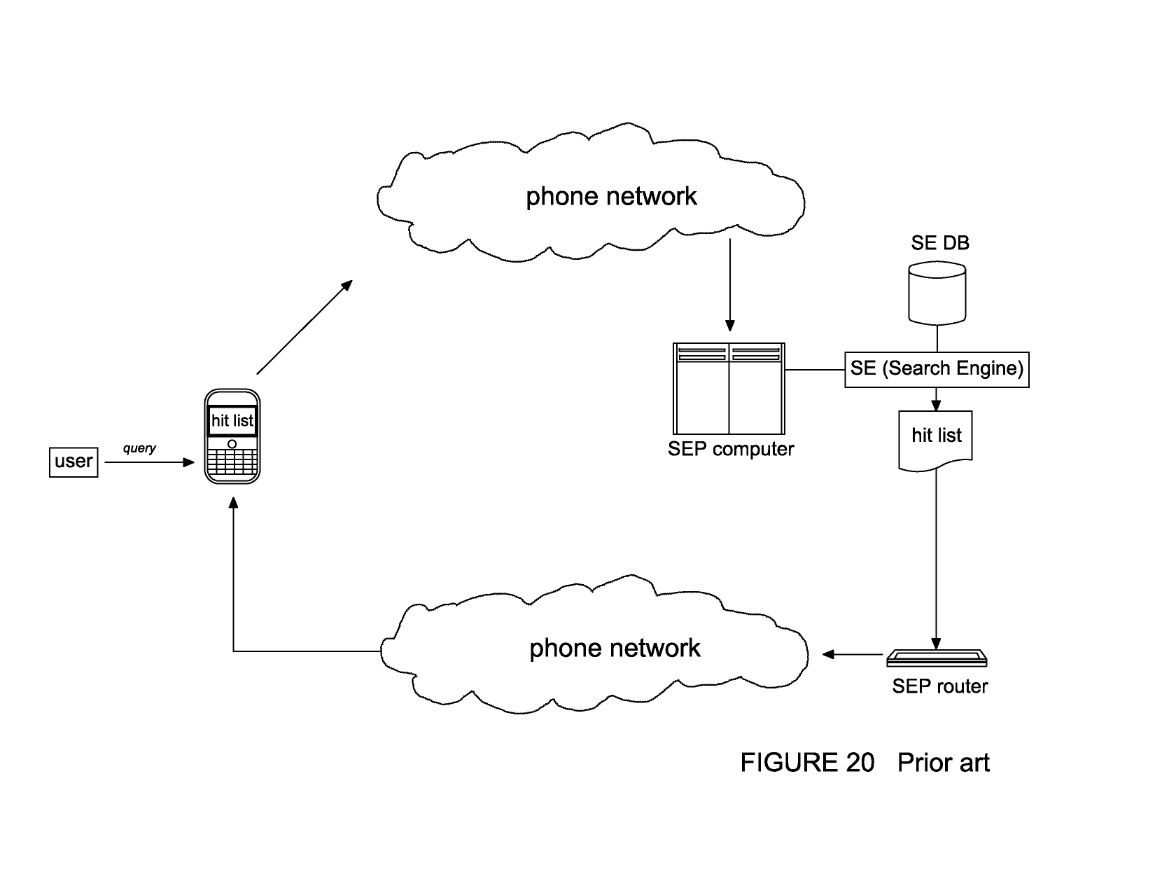

FIG. 20 (prior art) is used to describe how a typical Internet search is conducted using a mobile device such as a smart phone. The user enters a query (a search target), which is sent over the phone network to the Search Engine Provider's (SEP) computer to get processed by the Search Engine (SE), which searches the Internet as well as typically also its own database, generating a list of results (the “hit list”). The hit list is sent back through the phone network to the phone that originated the search, which then displays the hits list on its screen, primarily as a text list.

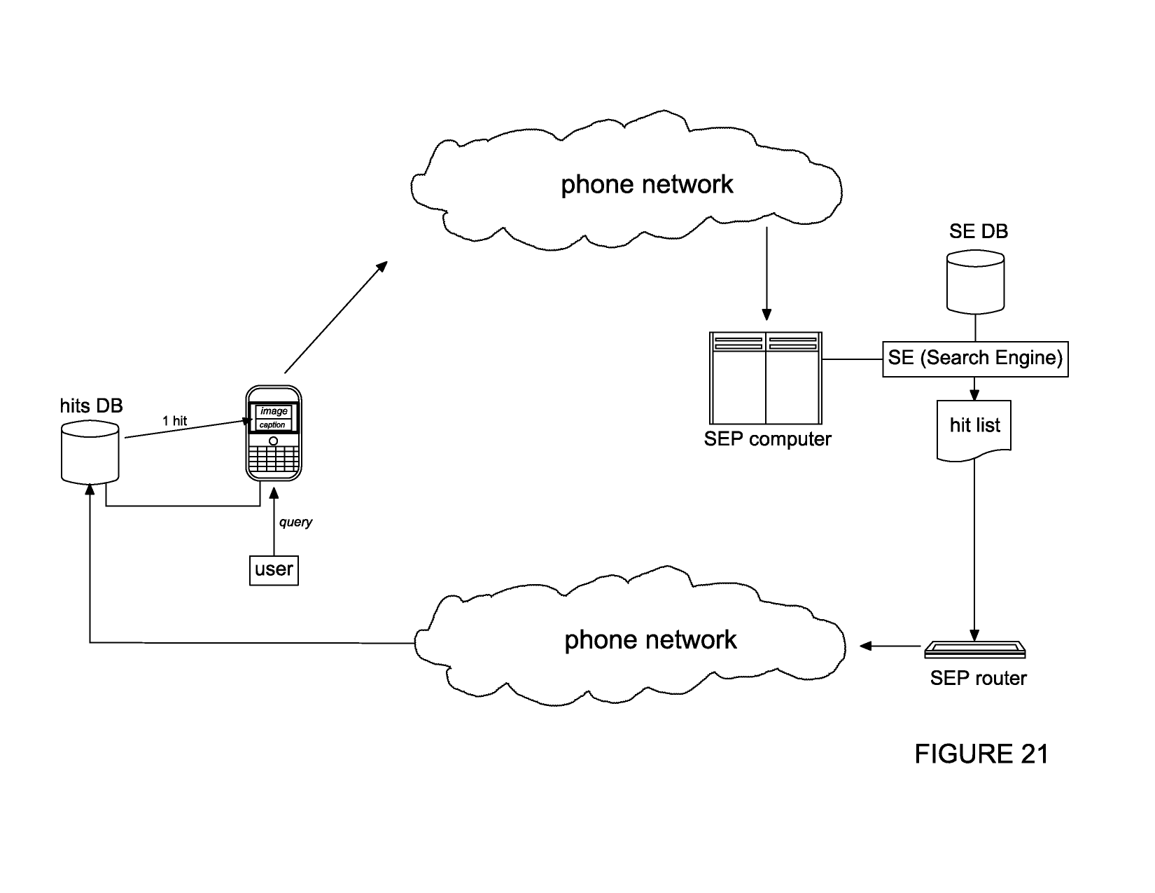

FIG. 21 describes a new search engine process using a smart phone to conduct the search. The user enters a query (a search target), which is sent over the phone network to the Search Engine Provider's (SEP) computer to get processed by the Search Engine (SE), which searches the Internet as well as typically also its own database, generating a hit list. The hit list is sent back through the phone network to the phone that originated the search. The phone saves the hit list in a data base or as a data buffer in its internal memory, from which a subset (preferably one hit at a time) is extracted to be displayed on the phone screen, as the user navigates through the list. The screen display is graphics oriented, consisting primarily of images with captions. The hits database or buffer may contain more than one hit list in order to allow the user to almost instantly view any hit related to his/her search (i.e. while the user is inspecting the hit list, other hit lists are downloaded from the search engine and loaded into the data base).

The above described embodiments can enable a transition from list-oriented display of searches (hit lists) with its inherent visibility and readability problems to object-oriented display, typically one hit at a time.

The invention also marks the transition from primarily text-oriented search results display to primarily image-oriented search results display, which is important in any device but particularly critical and enabling for mobile devices.

The above descriptions are examples of possible embodiments. The mention of Google, Yahoo, Apple, Blackberry, iPhone and other trade and product names is just for descriptive purposes, and the present invention is not limited to or specific to those products only. The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

What is claimed:

1. A search engine system comprising, in functional combination:
a search algorithm to conduct searches in the Internet and/or in a set of its own databases or files;
a communications system that allows the search engine to receive queries with search targets that users send from their devices, primarily computer and phone like devices, and send back to those devices the results of the search conducted by the search engine;
a display system with to communicate the results of the search to users in substantially small selectable amounts of information at a time to facilitate visibility and readability on a screen that includes at least one search results display panel and optionally one or more advertising panels.

2. The search engine system of claim 1 wherein the display screen for search results is split primarily in two vertical columns, one for search results and the other one for advertising.

3. The search engine system of claim 2 wherein the screen also includes a horizontal panel or banner for advertising purposes.

4. The search engine system of claim 1 wherein the sum of the number of entries into the advertising banner plus the number of hits displayed in the search results display panel is approximately four or less (see FIG. 5).

5. The search engine system of claim 1 wherein the maximum number of hits displayed in the search results display panel is approximately one (see FIG. 6).

6. The search engine system of claim 1 wherein every entry in the search results panel includes an image portion, if available, and a text portion (FIG. 7).

7. The search engine system of claim 1 wherein the user can easily navigate from one screen to the next to view the different items of the search results list by clicking on directional arrows or similar icons, causing another hit stored in memory or in storage to be instantly transferred to the screen (FIGS. 8 and 9).

8. The search engine system of claim 1 wherein the search results panel displays one hit at a time.

9. The search engine system of claim 1 wherein the search results panel displays one hit at a time, including an image area and a text area (FIG. 11).

10. The search engine system of claim 1 wherein both the search results panel and the advertising panel include an image area and a text area (FIG. 12).

11. The search engine system of claim 1 wherein the results are displayed in a screen that consists basically of two horizontal main areas: a search results panel and an advertising panel (FIG. 13).

12. The search engine system of claim 10 wherein the sum of the number of entries in the search results panel plus the number of entries in the advertising panel is not more than 4.

13. The search engine system of claim 10 wherein the sum of the number of entries in the search results panel plus the number of entries in the advertising panel is approximately 2 (one each).

14. The search engine system of claim 10 wherein the number of entries in the search results panel is approximately 1.

15. The search engine system of claim 10 wherein the entries consist primarily of images with optional captions.

16. The search engine system of claim 1 wherein the results are displayed in a screen that consists primarily of two vertical main areas: a search results panel and an advertising panel (FIG. 14).

17. The search engine system of claim 16 wherein the number of entries in the search results panel plus the number of entries in the advertising panel are approximately 2 (one each).

18. The search engine system of claim 8 wherein the entries consist primarily of images with optional captions.

19. The search engine system of claim 1 wherein the number of entries in the search results panel plus the number of entries in the advertising panel are approximately 3 (FIG. 17).

20. The search engine system of claim 1 which uses primarily images and graphics to communicate the results of a search to the user, with optional accompanying text (captions).

21. The search engine system of claim 1 which is especially adapted for use in small screens such as the screens of mobile devices by minimizing the amount of text that the user has to read, relying instead on images, icons, navigation buttons and graphic cues to see the results of a search and operate the device.

22. The search engine system of claim 1 wherein the search results are stored in a buffer, memory, cache or storage device and only a small subset of the hit list, typically only one hit at a time, is displayed on the screen, while also enabling the user to very quickly switch to another hit with a simple click (FIGS. 19 and 21).

23. The search engine system of claim 12 wherein additional searches of the same subject are conducted by the search engine while the user goes through the previous search results and the new results are stored in a buffer, memory, cache or storage device to have them instantly available if the user requests more search results, with the stored results being discarded if the user does not request them.
